(19) United States
(12) Patent Application Publication
(10) Pub. No.: US 2025/0289150 A1
(43) Pub. Date: Sep. 18, 2025

(54) MOTOR DRIVE UNIT FOR A ROBOT OR ROBOT JOINT, WITH BRAKE FUNCTIONALITY

(71) Applicant: Synapticon GmbH, Schönaich (DE)

(72) Inventors: Andrija FEHER, Schönaich (DE); Hannes SCHOENES, Schönaich (DE)

(21) Appl. No.: 18/860,419

(22) PCT Filed: Apr. 14, 2023
(86) PCT No.: PCT/IB2023/053845

§ 371 Date: Oct. 25, 2024

(30) Foreign Application Priority Data
Apr. 29, 2022 (DE) 10 2022 110 579.2

(51) Int. Cl. B25J 19/00; F16D 63/00; F16D 65/18; F16D 127/06

(52) U.S. Cl. CPC B25J 19/0004; F16D 63/006; F16D 65/186; F16D 2127/06

(57) ABSTRACT

The disclosure relates to a motor drive unit for a robot, with a housing; with a motor shaft element which is mounted rotatably about an axis of rotation (A) relative to the housing; with and a brake element comprising a ratchet. The brake element is connected to the housing and the ratchet is movable relative to the housing in order to enable a brake functionality of the motor drive unit, with the ratchet engaging an annular member in a locking position of the ratchet. A brake disc element which is attached on the motor shaft element and the annular member is rotatable relative to the brake disc element. At least one set of friction surfaces is provided in order to provide a given static friction or a given dynamic friction between the brake disc element and the annular member, where the friction surfaces extend in a plane perpendicular to the axis of rotation (A), in order to provide an improved brake functionality in a motor drive unit for a robot joint.

### FIELD OF INVENTION

The present disclosure relates to a motor drive unit for a robot or robot joint, with a housing, with a motor shaft element which is mounted rotatably about an axis of rotation relative to the housing, and with a brake element, the brake element comprising a ratchet. The brake element is connected to the housing and the ratchet is movable relative to the housing in order to enable a brake functionality of the motor drive, with the ratchet engaging, in a locking position of the ratchet, an annular member of the motor drive unit.

Robots such as manufacturing robots usually comprise a number of robot joints, which are driven by respective motor drive units. The motor drive units not only provide fast and precise actuating of the robot joins, but also feature a brake functionality. The corresponding brake mechanism should not only work reliably in ordinary situations, but also be fit for emergency braking.

Currently, there are two main brake technologies established for robot joints. One is a clutch style brake, the other a so-called pin brake. The known clutch style brakes are expensive, space consuming and heavy. Therefore, they are not considered in the following.

The pin brakes comprise an electromagnetic actuator that blocks the motor's rotation by bringing a pin in engagement with a rotating annular member of the motor. This rotating annular member may also be, due to its shape, referred as brake star. As compared with the clutch style brakes, the pin brakes are cheaper, lighter, smaller and easier to install and maintain.

An exemplary pin brake is described in the EP 3 045 273 B1, which describes a joint for a robot. Said document discloses a pin brake that can withstand a stop category zero (emergency case SCO) stopping. A stop category zero stopping is characterized by an immediate removal of power to the machine actuators, that is, it relates to an uncontrolled stop. An uncontrolled stop means stopping the machine motion by removing electrical power to the machine activators. So the pin of the electromagnetic actuator may engage with the rotating annular member of the motor drive at full speed. In such an emergency case SCO, usually the pin of a pin brake cannot withstand the resulting force. This is due to the fact that the rotating annular member, which is to be stopped by the pin, is connected to all rotating parts of the robot joint, such as rotor, shaft, gearbox, load, et cetera. Therefore, the inertia and the speed of the rotor and the other rotating parts would have to be absorbed by the pin. This damages either the pin or the interacting rotating annular member.

In EP 3 045 273 B1, this problem is overcome by adding a slip coupling between the brake star and the remaining rotating parts, which allows the brake star, when stopped by the pin, and, consequently, the pin of the braking mechanism to be decoupled from the load once the static friction of the slip coupling is overcome. However, the system described in EP 3 045 273 B1 is very space consuming and, in addition, does not result in a reliable, well-defined braking force.

The problem to be solved by the invention at hand may therefore be regarded as providing an improved brake functionality in a motor drive unit for a robot joint, in particular a brake functionality which allows a compact design of the motor drive unit.

### SUMMARY OF THE INVENTION

This problem is solved by the subject matter of the independent claim. Advantageous embodiments are apparent from the dependent claims, the description, and the figures.

One aspect relates to a motor drive unit for a robot joint, the motor drive unit comprising a housing, a motor shaft element, and a brake element with a ratchet. The housing may comprise a gear, as well as a motor stator, control electronics and further elements. The motor shaft element is arranged rotatably, that is, pivot-mounted, relative to the housing about an axis of rotation. The motor shaft element may be part of a rotor. The brake element is mechanically connected to the housing, that is attached to or fixed on the housing. The ratchet is movable in a linear direction back-and-forth relative to the housing between a locking position and a freed position in order to enable a brake functionality of the motor drive unit. To this end, the ratchet is configured to engage, in the locking position of the ratchet, in an annular member of the motor drive. In particular, the brake element may be configured for an emergency brake functionality, that is, for a stop category zero.

Furthermore, the motor drive unit comprises a brake disc element and the above-referenced annular member. The brake disc element is attached to, i.e. fixed or mounted onto the motor shaft element. The brake disc element may also be part of the motor shaft element, i.e. brake disc element and motor shaft element may be a one-piece design. Thus, the brake disc element in this case may also be considered as fixed onto the motor shaft element, as they are one piece. Preferably, the brake disc element and the motor shaft element rotate not only about the same axis of rotation, but also rotate with the same rotation speed. The annular member is mounted rotatably relative to the brake disc element and the housing, and about the same axis of rotation. Consequently, motor shaft element, annular member and brake disc element may be arranged concentrically.

At least one set of friction surfaces is provided in order to provide a given static friction and/or a given dynamic friction between the brake disc element and the annular member. Said friction may be referred to as braking friction, which is the friction that has to be adjusted/set for a proper braking functionality. Therein, one set of friction surfaces comprises two friction surfaces facing each other and providing, during intended use, static and/or dynamic friction by a physical interaction of the two surfaces. Corresponding surfaces may by the surfaces of any two elements of the motor drive unit that are next neighbours, i.e. surfaces of the brake disc element, the annular member, but also of the below-referenced spring element, bearing disc element or friction disc element. In any way, the friction surfaces extend in a plane perpendicular to the axis of rotation.

Preferably, the given static friction is chosen small enough to prevent the damage of the brake disc element or annular member in case of an emergency stop, and the given dynamic friction is chosen large enough to stop the motor fast enough for the application at hand. This may be achieved by a suitable choice of materials or coating of the respective friction surfaces, or additional elements such as the below-referenced spring element for increasing friction.

This gives the advantage that the friction required for the stop of the motor is realized on a clearly defined surface with a large diameter. The use of the brake disc element also changes the direction from a radial force required for the friction in the known state of the art to an axial force. The axial direction of the friction, that is the braking force of friction force of the braking functionality, and a larger diameter result in an increased leverage of the friction force for the braking. Therefore, the force required for braking is smaller and can be adjusted more precisely. Consequently, the design is also much more flexible in the dosage of the friction force. Furthermore, the size of the friction surface can be adjusted without the need for more space in the axial direction. Consequently, a more flexible, yet compact motor drive unit is realised.

In an advantageous embodiment, a spring element configured to press the annular member in a direction parallel to the axis of rotation towards the brake disc element or a part of the brake disc element is comprised by the motor drive unit. The spring element may have a ring shape and may be arranged concentrically to the annular member around the axis of rotation. This gives the advantage that the friction can be adjusted precisely and reliably, that is, without significant decrease over time. To this end, the spring element may be made from metal.

In another advantageous embodiment, the motor drive comprises a bearing disc element provided between the spring element and the annular member, preferably with the spring element mounted on the brake disc element or the motor shaft element. Preferably, the bearing disc element is a low friction bearing disc element. This means it is designed to provide only a minimal friction when rotated against a neighbouring element. This gives the advantage that the friction at the spring element and/or the shaft element is minimised, resulting in reduced tear of the spring element and/or the shaft element. This makes sure that the spring element maintains its spring force and thus makes sure the intended amount of friction is maintained throughout the lifetime of the motor drive without significant requirement for construction space.

In a further advantageous embodiment, the motor drive comprises a friction disc element provided between the annular member and the brake disc element. In particular, the annular member may be arranged in between the bearing element and the friction element in the axial direction. Preferably, the friction disc element is a high friction disc element. Consequently, as compared to the low friction bearing disc element described above, it provides a higher friction with adjoining elements. This gives the advantage that a higher friction between brake disc element and annular member can be realized, and, consequently, a faster braking can be realized in the same compact design.

Preferably, the bearing element and/or the friction element comprise, in addition to a disc part extending mainly perpendicular to the axis of rotation (a flange), a tube part adapted in its outer diameter to an inner diameter of the annular member. This gives the advantage that the respective elements can be put into one another, and hence provide a more precise guiding of the different elements with respect to each other. This results in a more precise and defined behavior of the brake.

In another advantageous embodiment, an inner diameter of friction surfaces providing friction between the brake disc element and annular member is at least 50%, preferably at least two times larger, even more preferably at least three times larger than a diameter of the motor shaft element. The diameter of the motor shaft element may be a smallest outer diameter of the motor shaft element and or an inner diameter of the motor shaft element. Preferably, the diameter of the motor shaft element is measured in direct vicinity of the brake disc element. This gives the advantage that the leverage of the friction force is improved, leading to a larger braking force without needing more space in the axial direction.

In yet another advantageous embodiment, the annular member comprises, at its radially outer face, at least one latch nose, preferably at least three latch noses, or lugs, that protrude from the main extension plane of the annular member into the direction parallel to the axis of rotation. Said latch nose(s) is (are) configured for engaging with the ratchet in the locking position of the ratchet only. The ratchet and the latch nose(s) may be configured such that, in the locking position, the ratchet does not extend into the main extension plane of the annular member. This gives the advantage that the braking force may be absorbed by deforming said latch nose(s) if the braking force is too large. Correspondingly, the latch nose(s) may be designed for absorbing a braking force, that is, designed to deform when the braking force is too large without the rest of the annular member being deformed. For instance, the latch nose(s) may be designed elastic. The use of the latch nose(s) also allows to move the ratchet in an effective locking position at high rotational speeds of the motor, depending on the number of latch noses. In principle, less latch noses allow for reaching a locking position by the ratchet at higher rotation speeds, but result in a larger backlash once the locking position is reached. This can be overcome by latch noses that taper towards their ends, or additional latch noses that extend, in the direction of the axis of rotation, less than the original latch noses. Then, the ratchet will first engage with the original latch noses to stop the motor shaft element, and with the additional latch noses to fix the motor shaft element in a given position with reduced backlash after the stop of the motor shaft element.

In a further advantageous embodiment, the motor drive unit comprises a magnetic and/or optic encoder target disc element, preferably made with or of a magnetic elastomer, the encoder target disc element applied on the brake disc element. This gives the advantage of less required space, as no separate encoder ring is required.

In another advantageous embodiment, the ratchet is movable parallel to the axis of rotation and is automatically driven into the locking position by a passive spring mechanism, with another, active mechanism holding the ratchet in a freed position while said other mechanism is activated. So, in the freed position, the annular member may rotate freely, without the ratchet engaging with it. This gives the advantage of a very simple emergency brake functionality, where a signal and/or electricity is actually required to hold the ratchet in the freed position, and a loss of signal/electricity automatically activates the brake mechanism as than the passive spring mechanism drives the ratchet into the locking position, when the other mechanism is deactivated due to lack of signal/electricity.

Further aspects relate to a robot joint or robot with a motor drive unit according to any of the described embodiments.

The features and combinations of features described above, also in the general intro as well as the features and combinations of features disclosed in the figure description or the figures alone may not only be used alone or in the described combination, but also with other features or without some of the disclosed features without leaving the scope of the invention. Consequently, embodiments that are not explicitly shown and described by the figures but that can be generated by separately combining the individual features disclosed in the figures are also part of the invention. Therefore, embodiments and combinations of features that do not comprise all features of an originally formulated independent claim are to be regarded as disclosed. Furthermore, embodiments and combinations of features that differ from or extend beyond the combinations of features described by the dependencies of the claims are to be regarded as disclosed.

### DETAILED DESCRIPTION

Exemplary embodiments are further described in the following by means of schematic drawings. Therein,

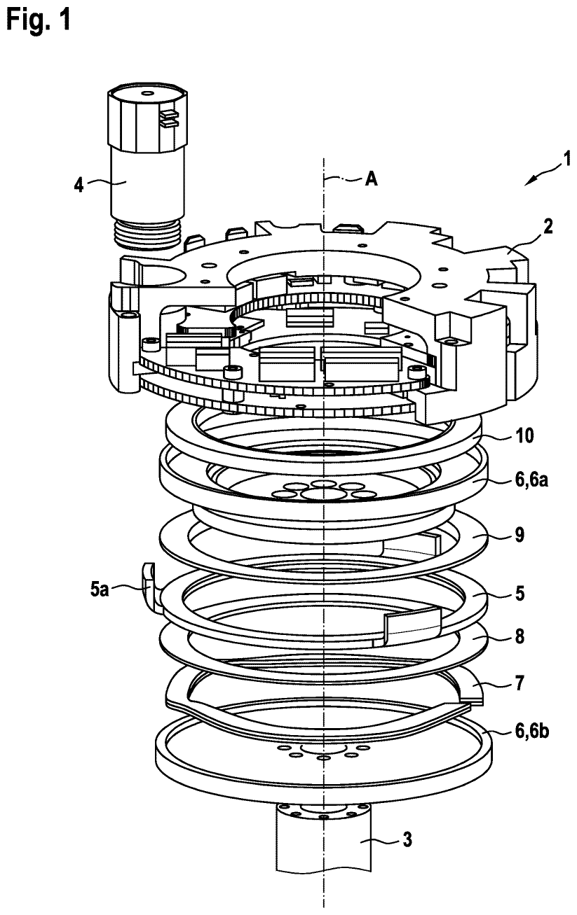

FIG. 1 shows an exploded view on an exemplary embodiment of a motor drive unit for a robot joint;

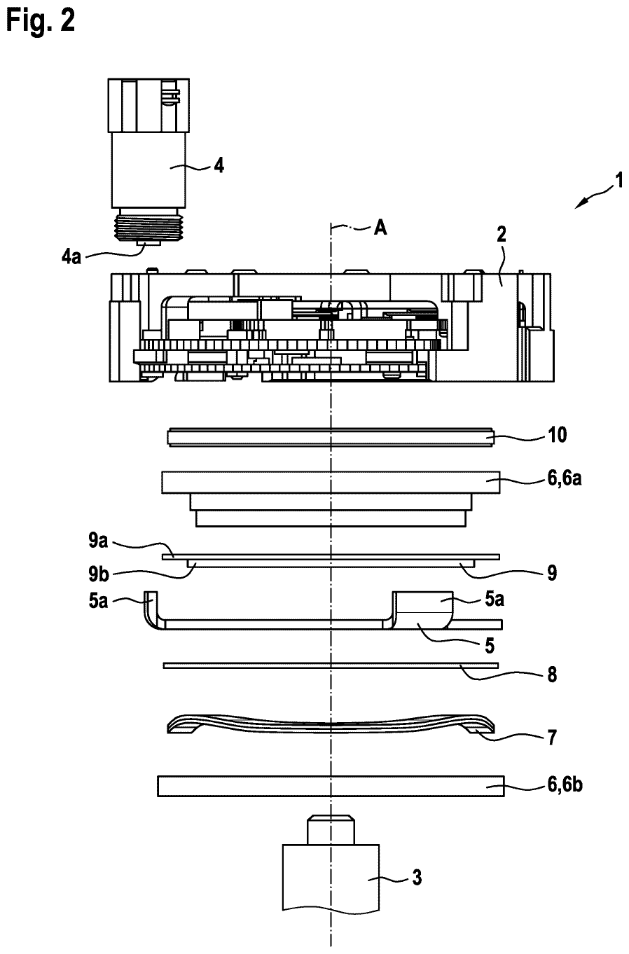

FIG. 2 shows a side view of the exemplary embodiment of FIG. 1; and

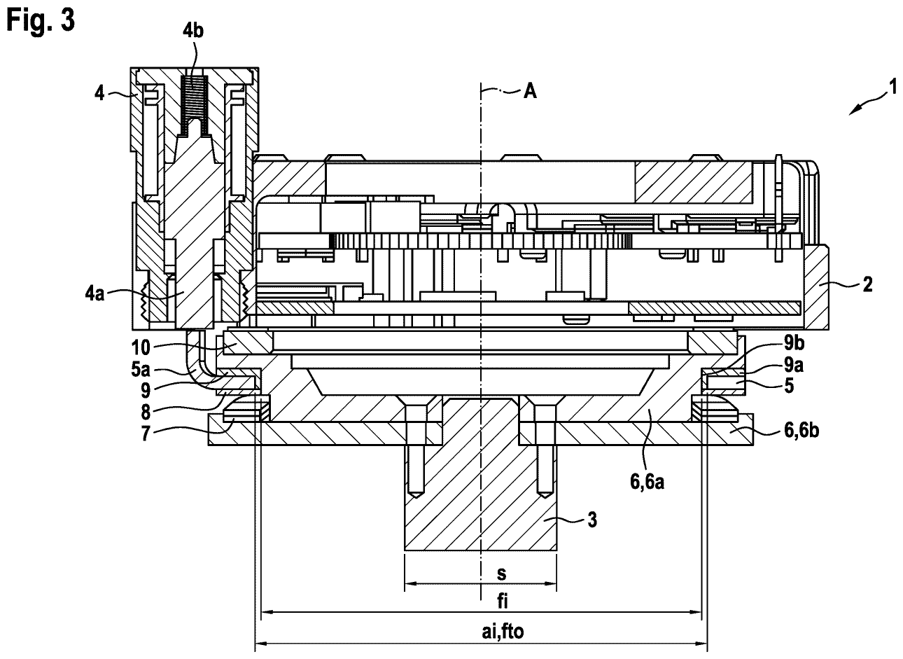

FIG. 3 shows a sectional view of said exemplary embodiment.

In the different figures, identical or functionally identical elements have the same reference signs.

FIG. 1 shows a motor drive unit 1 for a robot joint with a housing 2, a motor shaft element 3, and a brake element 4. The housing 2 comprises, in the present example, a gear and control units not described in detail here. The motor shaft element 3 is mounted rotatably about an axis of rotation A, rotatably relative to the housing 2. The brake element 4 comprises a ratchet 4a (FIGS. 2, 3), and is mechanically connected to the housing 2. The ratchet 4a is movable relative to the housing 2 in order to enable a brake functionality of the motor drive unit 1. To this end, the ratchet 4a may engage an annular member 5 in a locking position of the ratchet 4a. Furthermore, the motor drive unit 1 comprises a brake disc element 6, which fixed onto the motor shaft element 3. The annular member 5 is mounted rotatably relative to the brake disc element 6, as well as relative to the housing 2. Furthermore, at least one pair of friction surfaces provide for friction between the brake disc element 6 and the annular member 5. These friction surfaces extend in a plane perpendicular to the axis of rotation A.

In the present example, the brake disc element 6 is actually a sandwich brake disc element 6 with a first brake disc element part 6a and a second brake disc element part 6b, where additional element are arranged, in the present example, between the two parts 6a, 6b. This allows to preconfigure the brake disc element 6 including the additional elements and install these elements as on single entity, i.e. simply and reliably. In an alternative design, the function of second brake disc element part 6b could be provided by the motor shaft element 3. For example, motor shaft element 3 may form a support taking over the functions of the second brake disc element part 6b of the present example.

One of the exemplary additional elements is a spring element 7, which is ring-shaped here, arranged in the motor drive unit 1 to press the annular member 5 in a direction parallel to the axis of rotation A towards the brake disc element 6, that is, the first part 6a of brake disc element 6. A further exemplary additional element is a bearing disc element 8 provided between the spring element 7 and annular member 5, with the spring element 7 being mounted on the second part 6b of the brake disc element 6. The bearing disc element 8 is a low friction bearing element in the present example, and thus protects spring element 7 in case of a blocked annular member 5, i.e. in case of braking.

Another exemplary additional element is a friction disc element 9 provided between the annular member 5 and the brake disc element 6, the present example the first part 6a of the brake disc element 6. Here, the annular member 5 is arranged between the bearing element 8 and the friction element 9. As bearing element 8 is a low-friction element and friction disc element 9 is a high-friction element, the resulting friction between the annular member 5 and the brake disc element 6 is almost exclusively determined by the friction element 9 and the force by which the spring element 7 presses the annular member 5 towards the brake disc element 6. Thus, the friction can be defined, i.e. pre-set very precisely.

The present example, the motor drive unit 1 also comprises a magnetic encoder target disc element 10, which is ring-shaped and applied on the brake disc element 6, namely onto the first part 6a of brake disc element 6 here.

The annular member 5 comprises at least one latch nose 5a, here, exactly three latch noses 5a, which protrude from the main extension plane of the annular member 5 into the direction parallel to the axis of rotation A. Said latch noses 5a are configured for engaging with the ratchet 4a in the locking position of the ratchet 4a only.

FIG. 2 shows details of the friction element 9 with a disc part 9a extending mainly perpendicular to the axis of rotation A, and with a tube part 9b extending mainly along the axis of rotation A. The outer diameter fto of the tube part 9b is adapted to the inner diameter ai of the annular member 5 for a precise and reliable fit of friction element 9 and annular member 5. In FIG. 3, the different diameters are shown in more detail. So, the inner diameter fi of the friction surfaces provided by the friction element 9 and the brake disc element 6 is, in the present example, at least three times larger than the diameter s of the motor shaft element 3 in the vicinity of the brake disc element 6.

Consequently, the friction disc element 9, as well as the bearing disc element 8 provide a defined bearing and a defined friction torque between motor shaft element 3 and the annular member 5. This results in the absence of galling and longevity. The torque will, due to the spring element 7, stay constant over the life of the bearings and can be taken into consideration while dimensioning the braking torque of the system.

The latch noses 5a can also be made elastic, so that a big hit taking place in an emergency braking situation can be absorbed by a spring-like elastic structure which is only subject to elastic deformation, and does not have to be absorbed by harder parts or elements of the motor drive unit. So, the energy of the emergency braking moment can at least in part be absorbed by an elastic deformation, and resorped when the static friction is overcome.

In the following, the working of the braking mechanism of the show motor drive unit 1 is described shortly:

When the brake element 4 is not braking, that is, the ratchet 4a is held back against the spring force provided by the spring mechanism 4b and thus not engaging the annular member 5, the annular member 5 is rotating freely with the same rotation speed as the motor shaft element 3 due to the friction between annular member 5 and brake disc element 6.

The moment an (emergency) brake situation occurs and the ratchet 4a is driven forward towards the annular member 5 in the direction parallel to the axis of rotation A, it at some point engages with one of the latch noses 5a. Consequently, the annular member 5 stops its rotation immediately in spite the static friction force between annular member 5 and friction disc element 9. Once the static friction force is overcome, the dynamic friction force or slipping force between the stopped annular member 5 and the still rotating brake disc element 6, slows down the rotation of the motor shaft element 3, and thus realizes the brake functionality.

1. A motor drive unit for a robot, comprising:
a housing:
a motor shaft element which is mounted rotatably about an axis of rotation (A) relative to the housing;
a brake element comprising a ratchet, where the brake element is connected to the housing and the ratchet is movable relative to the housing in order to enable a brake functionality of the motor drive unit, with the ratchet engaging an annular member in a locking position of the ratchet; and
a brake disc element which is attached to the motor shaft element, wherein
the annular member is rotatable relative to the brake disc element, and
at least one set of friction surfaces is provided in order to provide a given static friction or a given dynamic friction between the brake disc element and the annular member, where the friction surfaces extend in a plane perpendicular to the axis of rotation (A).

2. The motor drive unit according to the preceding claim 1, further comprising:
a spring element configured to press the annular member in a direction parallel to the axis of rotation (A) towards at least a part of the brake disc element.

3. The motor drive unit according to claim 2, further comprising:
a bearing disc element provided between the spring element and the annular member.

4. The motor drive unit according to any one of the claim 3, further comprising:
a friction disc element provided between the annular member and the brake disc element, with the annular member being arranged in between the bearing disc element and the friction disc element.

5. The motor drive unit according to any claim 4,
wherein the bearing disc element and/or the friction disc element comprise, in addition to a disc part extending mainly perpendicular to the axis of rotation (A), a tube part adapted in its outer diameter (fto) to an inner diameter (ai) of the annular member.

6. The motor drive unit according to claim 1,
wherein an inner diameter of the friction surfaces (fi) providing friction between the brake disc element and the annular member is at least 50% larger than a diameter(s) of the motor shaft element.

7. The motor drive unit according to claim 1,
wherein the annular member comprises, at its outer face, at least one latch nose protruding from the main extension plane of the annular member into the direction parallel to the axis of rotation (A), where said at least one latch nose is configured for engaging with the ratchet in the locking position of the ratchet only.

8. The motor drive unit according to claim 1, further comprising:
a magnetic and/or optic encoder target disc element applied on the brake disc element.

9. The motor drive unit according to any one of the claim 1,
wherein the ratchet is movable parallel to the axis of rotation (A) and driven into the locking position by a spring mechanism, with another mechanism holding the ratchet in a freed position when said another mechanism is activated.

10. A robot joint having the motor drive unit according to claim 1.

11. The motor drive unit according to claim 1,
wherein an inner diameter of the friction surfaces (fi) providing friction between the brake disc element and the annular member is at least two times larger than a diameter of the motor shaft element.

12. The motor drive unit according to claim 8,
wherein the encoder target disc element comprises a magnetic elastomer.

13. A mobile robot having the motor drive unit according to claim 1.

14. A motor drive unit for a robot joint, comprising:
a housing;
a motor shaft element which is mounted rotatably about an axis of rotation (A) relative to the housing;
a brake element comprising a ratchet, where the brake element is connected to the housing and the ratchet is movable relative to the housing in order to enable a brake functionality of the motor drive unit, with the ratchet engaging an annular member in a locking position of the ratchet; and
a brake disc element which is attached to the motor shaft element, wherein,
the annular member is rotatable relative to the brake disc element, and
at least one set of friction surfaces is provided in order to provide a given static friction or a given dynamic friction between the brake disc element and the annular member, where the friction surfaces extend in a plane perpendicular to the axis of rotation (A).

15. The motor drive unit according to claim 1,
wherein the annular member comprises, at its outer face, at least three latch noses protruding from the main extension plane of the annular member into the direction parallel to the axis of rotation (A), where said latch noses are configured for engaging with the ratchet in a locking position of the ratchet only.
